(19) United States
(12) Patent Application Publication
(10) Pub. No.: US 2009/0186199 A1
(43) Pub. Date: Jul. 23, 2009

(54) Bis-(OH-triazinyl)-bridged Azo Dyes, Ink, Process and Use

(75) Inventor: Gavin Wright, Manchester (GB)

Correspondence Address: MORGAN LEWIS & BOCKIUS LLP, 1111 PENNSYLVANIA AVENUE NW, WASHINGTON, DC, 20004, US

(73) Assignee: FUJIFILM IMAGING COLORANTS LIMITED, Blackley, Manchester (GB)

(21) Appl. No.: 12/300,483

(22) PCT Filed: May 14, 2007
(86) PCT No.: PCT/GB2007/001773

§ 371 Date: Nov. 12, 2008

(30) Foreign Application Priority Data
Jun. 17, 2006 (GB) 0612029.9

(51) Int. Cl. B32B 5/00; C09B 33/12; C09D 11/02; B05D 5/00

(52) U.S. Cl. 428/195.1; 534/797; 106/31.48; 427/256

(57) ABSTRACT

A compound of Formula (1) or a salt thereof:

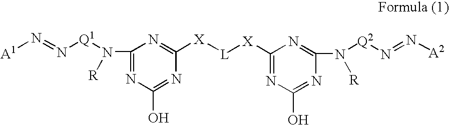

wherein:
A¹ and A² are each independently optionally substituted aryl;
Q¹ and Q² are each independently an optionally substituted arylene or polycyclic heteroarylene group each comprising a phenylene ring which is para connected to the —N═N— and the —NR— groups shown in Formula (1);
each R is independently H or a substituent;
each X is independently selected from O, S or NR^{a} wherein R^{a} is H or a substituent, provided that at least one of the groups represent by X is O or S;
L is a linking group; and
   provided that the groups represented by the formula XLX do not contain any group selected from sulfonic acid, phosphonic acid, carboxylic acid and sulfonamide groups. Inks containing these compounds, have particularly good ozone-fastness, optical density, colour space and especially good light-fastness.

This invention relates to compounds which are useful as colorants, to inks (especially ink jet printing inks) containing said compounds, to a process for printing said ink on a substrate and to the use of said compounds for preparing aqueous inks. Ink jet printing (hereinafter IJP) is a non-impact printing technique in which droplets of ink are ejected through a fine nozzle onto a substrate without bringing the nozzle into contact with the substrate.

There are many demanding performance requirements for colorants and inks used in IJP. For example, they desirably provide sharp, non-feathered images having good water-fastness, light-fastness, ozone-fastness and optical density. The inks are often required to dry quickly when applied to a substrate to prevent smudging, but they should not form a crust over the tip of an ink jet nozzle because this will tend to reduce print quality and in extreme cases may prevent the printer from printing. The inks should also be stable to storage over time without decomposing or forming a precipitate which could block the fine nozzle.

Azo containing colorants are known in the art.

WO 00/015723 discloses a composition containing a dye having two azo groups linked, for example, via two triazine rings and a linking group.

We have surprisingly found a new group of compounds which are especially suitable as colorants for use in ink jet printing inks and which provide one or more of the aforementioned desirable properties.

According to the present invention there is provided a compound of Formula (1) or a salt thereof.

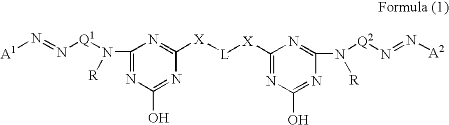

wherein.
A¹ and A² are each independently optionally substituted aryl;
Q¹ and Q² are each independently an optionally substituted arylene or polycyclic heteroarylene group each comprising a phenylene ring which is para connected to the —N═N— and the —NR— groups shown in Formula (1);
each R is independently H or a substituent;
each X is independently selected from O, S or NR^{a} wherein R^{a} is H or a substituent, provided that at least one of the groups represent by X is O or S;
L is a linking group; and
   provided that the groups represented by the formula XLX do not contain any group selected from sulfonic acid, phosphonic acid, carboxylic acid and sulfonamide groups.

### A¹ and A²

A¹ and A² may each independently be either an optionally substituted polycyclic aryl group or a monocyclic aryl group.

Preferred polycyclic aryl groups include naphthyl, anthracyl and pyrenyl groups. A preferred monocyclic aryl group is a phenyl group. Preferably, the as naphthyl is 2-naphthyl.

Preferably, A¹ and A² are each independently naphthyl or phenyl.

Preferably, A¹ and A² are the same.

Preferably, both A¹ and A² are naphthyl, more preferably 2-naphthyl.

The optional substituents which may be present on A¹ and A² are preferably each independently selected from optionally substituted alkyl, alkoxy, amine, amide, ester, ketone, thioether, halo, acid, hydroxy, nitro, cyano and —CF₃ groups.

Preferably, the optionally substituted alkyl group is a C₁₋₈ alkyl group, more preferably an optionally substituted C₁₋₄ alkyl group.

Preferably, the optionally substituted alkoxy group is a C₁₋₈-alkoxy group, more preferably an optionally substituted C₁₋₄-alkoxy group.

Preferably, the optionally substituted amine group is of the formula —NR¹R² wherein R¹ and R² are each independently H or optionally substituted alkyl, aryl or heteroaryl, or R¹ and R² together with the nitrogen atom to which they are attached form an optionally substituted 5- or 6-membered ring (e.g. a piperidine, pyrrolidone, pyridine, piperizine or morpholine ring).

Preferably, the optionally substituted amide group is of the formula —NHC(O)NR¹R², —C(O)NR¹R², —S(O)₂NR¹R² or —NHC(O)R³, wherein R³ is H or optionally substituted alkyl, aryl or heteroaryl and R¹ and R² are as hereinbefore defined.

Preferred optionally substituted ester groups are of the formula —C(O)OR⁴ or —S(O)₂OR⁴, wherein R⁴ is optionally substituted alkyl, aryl or heteroaryl.

Preferred optionally substituted ketone groups are of the formula —C(O)R⁴ wherein R⁴ is as hereinbefore defined.

Preferred optionally substituted thioether groups are of the formula —SR⁴, wherein R⁴ is as hereinbefore defined.

Optionally substituted alkyl, aryl, heteroaryl, alkoxy, amine, amide, ester, ketone or thioether substituents may have one or more halo, amino, C₁₋₄-alkoxy, hydroxy, and acid groups.

Preferred halo groups are Cl, F and Br.

Preferred acid groups are carboxylic acid, sulfonic acid and phosphonic acid groups.

Preferably, A¹ and A² each independently have from 1 to 4, more preferably from 1 to 3 groups selected from carboxylic acid, phosphonic acid and sulfonic acid groups. More preferably A¹ and A² each independently have from 1 to 3 sulfonic acid groups. In addition, although it is not preferred, A¹ and A² may have one or more substituents other than carboxylic acid, phosphonic acid and sulfonic acid groups.

Preferably, A¹ and A² are each independently of Formula (2) or a salt thereof or Formula (3) or a salt thereof:

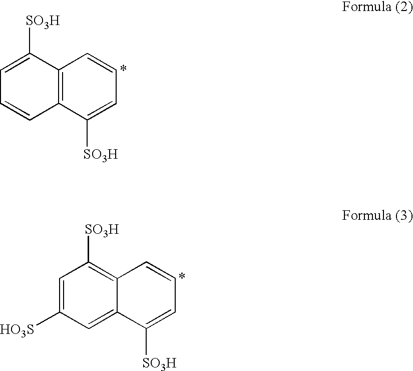

wherein the asterisk represents the point of attachment to the —N═N— group.

### Q¹ and Q²

Preferably both Q¹ and Q² are arylene groups, more preferably Q¹ and Q² are the same arylene group.

The arylene group may be either polycyclic (e.g. naphthylene) or monocyclic (e.g. phenylene).

Preferably, Q¹ and Q² are each independently optionally substituted naphthylene or phenylene, more preferably both Q¹ and Q² are optionally substituted phenylene, in each case comprising a phenylene ring which is para connected to both the —N═N— and the —NR— groups shown in Formula (1).

Preferably, the optionally substituted polycyclic heteroarylene groups comprise a phenylene ring condensed with a 5- or 6-membered ring comprising one or more nitrogen, sulphur, oxygen or phosphorus atoms in the 5- or 6-membered ring (e.g. an indole group comprising a phenylene ring which is para connected to both the —N═N— and the —NR— groups in Formula (1)).

The optional substituents which may be present on Q¹ and Q² are preferably any of those described above for A¹ and A².

The optional substituents which may be present on Q¹ and Q² are preferably selected from C₁₋₄-alkoxy (especially methoxy and ethoxy), C₁₋₄-alkyl (especially methyl), —NHCONH₂, —NHSO₂—C₁₋₄-alkyl (especially —NHSO₂CH₃), carboxylic acid, sulfonic acid and phosphonic acid.

Preferably, the groups represented by Q¹ and Q² are independently unsubstituted or are substituted with only one C₁₋₄ alkyl or C₁₋₄ alkoxy group.

More preferably, both Q¹ and Q² are unsubstituted.

### R Groups

Preferably, each R independently is H, optionally substituted alkyl or optionally substituted aryl. Preferred optionally substituted alkyl and optionally substituted aryl groups are as mentioned above for A¹ and A². More preferably each R independently is H or C₁₋₄-alkyl, especially H.

### X

Preferably both of the groups represented by X are each independently selected from O and S. More preferably, both of the groups represented by X are or more preferably S.

When one of the groups represented by X is —NR^{a}— then R^{a} is preferably H. R^{a} may also be a substituent which is preferably optionally substituted alkyl or optionally substituted aryl. Preferred optionally substituted alkyl and optionally substituted aryl groups are as mentioned above for A¹ and A², with the exception of any group which is or contains a sulfonic acid, phosphonic acid, carboxylic acid or sulfonamide group.

### Linking Group L

Preferably, the linking group L is organic (i.e. L comprises at least one carbon atom).

The linking group L may be an optionally substituted and/or optionally interrupted arylene or alkylene.

Preferred optional substituents attached to L are those as described above for A¹ and A², with the exception of any group which is or contains a sulfonic acid, phosphonic acid, carboxylic acid or sulfonamide group.

In one embodiment the linking group L may be an optionally substituted alkylene optionally interrupted with one or more —S—, —O—, —N—, —C(O)O—, —C(O)NH—, —C═C—, —C≡C— arylene or heteroarylene groups. The alkylene is preferably a C₁₋₃₀-alkylene, more preferably a C₂₋₁₀-alkylene.

Preferred linking groups of this type are alpha, omega diols and thiols of linear C₂₋₁₀ aliphatic hydrocarbons.

In another embodiment L is a group of formula —[(CH₂)ₙ-Z]ₘ-(CH₂)ₙ— wherein n is from 1 to 4, m is from 1 to 10 and each Z independently is selected from O, S and —NR^{b}— groups wherein R^{b} is optionally substituted alkyl, optionally substituted aryl or more preferably H. Preferred optionally substituted alkyl and optionally substituted aryl groups are as mentioned above for A¹ and A² with the exception that the optional substituent cannot be or contain a carboxylic acid, sulfonic acid, phosphonic acid or sulphonamide group.

Preferably, n is 2 or 3. Preferably, m is 1 or 2 and especially n is 2 or 3 and m is 1 or 2.

More preferably, Z is selected from O and S and especially all the groups represented by X and Z are either O or S.

Preferrably, the residue represented by the groups -XLX- is of the formula —O(CH₂)₁₆O—, —O(CH₂)₂N(CH₃)(CH₂)₂O—, —OCH₂CH₂OCH₂CH₂OCH₂CH₂O—, —OCH₂CH₂OCH₂CH₂O—, —OCH₂CH₂SCH₂CH₂O—, —O(CH₂)₃S(CH₂)₃O—, —O(CH₂)₄O—, —OCH₂CH₂C(CH₃)CH₂CH₂O—, —O(CH₂)₃—O—(CH₂)₃O—, —S(CH₂)₈S—, —SCH₂CH₂OCH₂CH₂S—, —S(CH₂)₄S—, —S(CH₂)₆S—, —SCH₂CH₂OCH₂CH₂OCH₂CH₂S—, —S(CH₂)₁₀S—, —SCH(CH₃)CH₂CH₂S—, —SCH₂CH₂SCH₂CH₂S— or —SCH₂CH₂SCH₂CH₂CH₂SCH₂CH₂S—.

A particularly preferred residue represented by the groups -XLX- is of the formula —SCH₂CH₂SCH₂CH₂S—.

### PREFERRED EMBODIMENTS

In a preferred embodiment the compound of Formula (1) is any of the compounds of Formulae (4) to (6) or salts thereof:

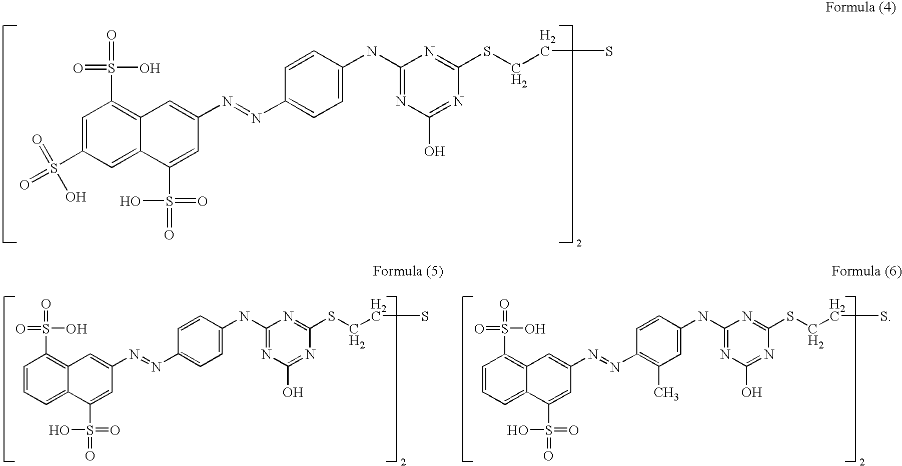

The compounds of Formula (1) exist in tautomeric forms other than those shown in this specification and such tautomers are included within the scope and claims of the present invention.

The compound of Formula (1) may be in the protonated or salt form or a mixture thereof.

Accordingly, when the compound of Formula (1) contains groups such as sulfonic acids phosphonic acid or carboxylic acid these may be in the form of the free acid (e.g. —SO₃H) or in the form of a salt (e.g. —SO₃Na).

Preferred salt forms are water-soluble, for example alkali metal salts (especially lithium, sodium, potassium), ammonium, substituted ammonium and mixed salts thereof. Preferred ammonium and substituted ammonium salts are ammonium and alkyl or aryl substituted ammonium (e.g. ammonium, alkanolammonium, pyridinium, piperidinium and morpholinium). It is especially preferred that the compounds of Formula (1) are in the form of a sodium, lithium, potassium or ammonium salt or a mixture thereof.

Preferably, the compound of Formula (1) has from 1 to 10 and especially from 2 to 8 groups selected from sulfonic acid, phosphonic acid and carboxylic acid groups.

Preferably, the compound of Formula (1) is a dye, more preferably a water-soluble dye.

Preferably, the compound of Formula (1) is yellow, orange or brown in colour. Preferably, inks containing about 5% by weight of the compound of Formula (1) are yellow in colour.

The compounds of the present invention are useful for preparing inks (especially IJP inks). These inks, when printed, exhibit particularly good ozone fastness, optical density, colour space and especially good light fastness.

Compounds of Formula (1) are preferably free from fibre reactive groups because such groups tend to reduce the long-term storage stability of inks. The term fibre reactive group is well understood in the art and is used for example in EP 0356014 A¹. Fibre reactive groups are capable, under suitable conditions, of reacting with the hydroxy groups present in cellulosic fibres or with the amino groups present in natural fibres to form a covalent linkage between the fibre and the compound. The compounds of Formula (1) and salts thereof may optionally be present with one or more further colorants other than compounds of Formula (1) or a salt thereof. Such further colorants, when present, are preferably free from fibre reactive groups.

The compounds of Formula (1) or a salt thereof may be prepared by hydrolysis of the compound of Formula (7) or a salt thereof:

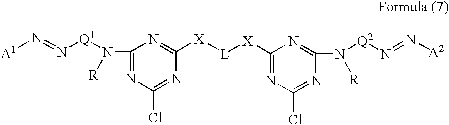

wherein A¹, A², Q¹, Q², is X and L are as hereinbefore defined.

Preferably, the hydrolysis is performed in an alkaline solution containing sodium or lithium hydroxide at a temperature of 60 to 80° C. for a period of 4 to 10 hours.

The compound of Formula (7) or a salt thereof is preferably prepared by reacting about 1 mole of a compound of formula HXLXH with 1 mole of a compound of Formula (8a) or a salt thereof and 1 mole of a compound of Formula (8b) or a salt thereof:

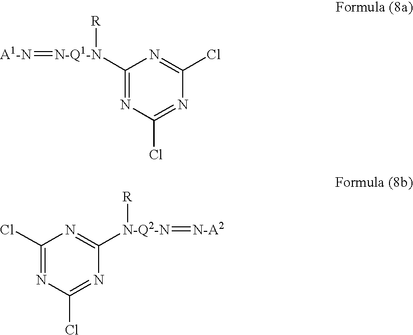

wherein A¹, A², Q¹, Q², R, X and L are as hereinbefore defined.

The reaction is preferably performed in aqueous solution at a temperature of from 20 to 40° C. and a pH of from 6 to 7.

For symmetrical compounds of Formula (1) or a salt thereof, HXLXH may be reacted with about two moles of a compound of Formula (8a) or a salt thereof.

The compound of Formula (8a) or a salt thereof is preferably prepared by reacting about 1 mole of cyanuric chloride with about 1 mole of a compound of Formula (9a) or a salt thereof.

A¹-N═N-Q¹-NRH Formula (9a)

wherein A¹, Q¹ and R are as hereinbefore defined.

Compounds of Formula (8b) or a salt thereof are prepared in exactly the same way as compounds of Formula (8a) or a salt thereof except that the compound of Formula (9b) or a salt thereof replaces the compound of Formula (9a) or a salt thereof.

A²-N═N-Q²-NRH Formula (9b)

wherein A², Q² and R are as hereinbefore defined.

The compounds of Formula (9a) or salts thereof may be prepared by diazotising a compound of the Formula A¹-NH₂ to give a diazonium salt and coupling the resultant diazonium salt with a compound of Formula Q¹-NRH, wherein A¹, Q¹ and R are as hereinbefore defined.

The compounds of Formula (9b) or salts thereof may be prepared in an analogous manner to those of Formula (9a) or salts thereof by diazotising a compound of Formula A²-NH₂ to give a diazonium salt and coupling the resultant diazonium salt with a compound of Formula Q²-NRH, wherein A², Q² and R are as hereinbefore defined.

The diazotisation is preferably performed at a temperature below 20° C., more preferably at a temperature from 0° C. to 5° C. Preferably, the diazotisation is performed in a liquid comprising water, preferably having a very acidic pH (below 3). Mineral acids (e.g. HCl or H₂SO₄ or mixtures thereof) are typically used to achieve such an acidic pH.

The coupling reaction is preferably performed at a temperature of from 0 to 5° C., typically for a period of 1 to 6 hrs. It is often desirable to add a buffer (e.g. sodium acetate) to adjust the pH to 4 to 5. The coupling reaction is preferably performed in a liquid comprising water. The coupling reaction is preferably continued for a further period of 16 hours at 25° C.

### Compounds of Formula HXLXH

Preferred compounds of Formula HXLXH include HO(CH₂)₁₆OH, HO(CH₂)₂N(CH₃)(CH₂)₂OH, HOCH₂CH₂OCH₂CH₂OCH₂CH₂OH, HOCH₂CH₂OCH₂CH₂OH, HOCH₂CH₂SCH₂CH₂OH, HO(CH₂)₃S(CH₂)₃OH, HO(CH₂)₄OH, HOCH₂CH₂C(CH₃)CH₂CH₂OH, HO(CH₂)₃—O—(CH₂)₃OH, HS(CH₂)₈SH, HSCH₂CH₂OCH₂CH₂SH, HS(CH₂)₄SH, HS(CH₂)₆SH, HSCH₂CH₂OCH₂CH₂OCH₂CH₂SH, HS(CH₂)₁₀SH, HSCH(CH₃)CH₂CH₂SH, HSCH₂CH₂SCH₂CH₂SH and HSCH₂CH₂SCH₂CH₂CH₂SCH₂CH₂SH.

A preferred compound of Formula HXLXH is HSCH₂CH₂SCH₂CH₂SH.

### Inks

According to a second aspect of the present invention there is provided an ink comprising:
(a) at least one compound of Formula (1) or a salt thereof according to the first aspect of the present invention; and
(b) a medium.

The medium is preferably a liquid medium or a low melting point solid medium.

More preferably, the ink according to the second aspect of the present invention comprises:
(a) from 0.01 to 30 parts of at least one compound of the Formula (1) or a salt thereof; and
(b) from 70 to 99.99 parts of a liquid medium or a low melting point solid medium;
   wherein all parts are by weight and the number of parts of (a)+(b)=100.

The number of parts of component (a) is preferably from 0.1 to 20, more preferably from 0.5 to 15, and especially from 1 to 5 parts. The number of parts of component (b) is preferably from 99.9 to 80, more preferably from 99.5 to 85, especially from 99 to 95 parts.

Preferably, component (a) is completely dissolved in component (b).

Preferably, component (a) has a solubility in component (b) at 20° C. of at least 10% by weight. This allows the preparation of concentrates which may be used to prepare more dilute inks and reduces the chance of the compound of Formula (1) or a salt thereof precipitating if evaporation of the liquid medium occurs during storage.

Preferred liquid media include water, a mixture of water and an organic solvent and an organic solvent free from water. Preferably, the liquid medium is or comprises water.

When the liquid medium comprises a mixture of water and an organic solvent, the weight ratio of water to organic solvent is preferably from 99:1 to 1.99, more preferably from 99:1 to 50:50 and especially from 95:5 to 80:20.

It is preferred that the organic solvent present in the mixture of water and organic solvent is a water-miscible organic solvent or a mixture of such solvents.

Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulphoxides, preferably dimethyl sulphoxide and sulpholane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

A preferred liquid medium comprises:

(a) from 75 to 95 parts water; and
(b) from 25 to 5 parts in total of one or more organic solvents selected from diethylene glycol, 2-pyrrolidone, thiodiglycol, N-methylpyrrolidone, cyclohexanol, caprolactone, caprolactam and pentane-1,5-diol;
wherein the parts are by weight and the sum of the parts (a) and (b)=100.

Examples of further suitable ink media comprising a mixture of water and one or more organic solvents are described in U.S. Pat. No. 4,963,189, U.S. Pat. No. 4,703,113, U.S. Pat. No. 4,626,284 and EP 4,251,50A.

When the liquid medium comprises an organic solvent free from water, (i.e. less than 1% water by weight) the organic solvent preferably has a boiling point of from 300 to 200° C., more preferably of from 300 to 150° C., especially from 30 to 125° C. The organic solvent may be water-immiscible, water-miscible or a mixture of such solvents. Preferred water-miscible organic solvents are any of the hereinbefore described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the dye in the liquid medium. Examples of polar solvents include C₁₋₄-alcohols and ketones.

In view of the foregoing preferences it is especially preferred that when the liquid medium is an organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is an organic solvent free from water it is a mixture of 2 to 5 different organic solvents. This allows a liquid medium to be selected which gives good control over the drying characteristics and storage stability of the ink.

Ink media comprising an organic solvent free from water are particularly useful where fast drying times are required and particularly when printing onto hydrophobic and non-absorbent substrates, for example plastics, metal and glass.

### Hot-Melt Inks

Preferably, the low melting point solid is solid at 25° C. and melts at a temperature above 50° C. More preferably, the low melting point solid has a is melting point in the range from 60° C. to 125° C.

Suitable media which melt in this temperature range include long chain fatty acids, sulfonamides or alcohols, preferably those having C₁₈₋₂₄ chains. The compound of Formula (1) or a salt thereof may be dissolved in the low melting point solid or may be finely dispersed in it.

### Additives

The ink according to the second aspect of the present invention may also contain additional components suitable for use in ink jet printing inks, for example viscosity and surface tension modifiers, corrosion inhibitors, biocides, kogation reducing additives and surfactants.

### Ink Characteristics

The viscosity of the ink is preferably less than 50 mPa·s, more preferably less than 20 mPa·s and especially less than 5 mPa·s. The viscosity is preferably measured at a temperature of 25° C. Preferably, the viscosity is measured by means of a cone and plate rheometer at a shear rate corresponding to 100 rpm. Preferably, the ink is Newtonian in its viscosity behaviour (i.e. the viscosity is insensitive to shear rate).

Preferably, the ink has been filtered through a filter having an average pore size of less than 10 microns, More preferably the ink has been filtered through a filter having an average pore size of from 10 to 0.2, more preferably from 5 to 1 micron.

Preferably the ink has a concentration of halide ions of less than 500 parts per million and more preferably less than 100 parts per million. It is especially preferred that the ink has less than 100, more preferably less than 50 parts per million in total of divalent and trivalent metals. Parts per million refer to parts by weight of the relevant ions or metals relative to the total weight of the ink. Any suitable means to remove halide ions and/or di and trivalent metals may be employed, e.g. ion exchange and ultra-filtration.

### Printing Process

According to a third aspect of the present invention there is provided a process for printing an image on a substrate comprising applying an ink containing a compound of Formula (1) or a salt thereof according the first aspect of the present invention to the substrate.

Preferably, the ink is applied by means of an ink jet printer.

The ink used in this process is preferably that according to the second aspect of the present invention.

### Substrate

According to a fourth aspect of the present invention there is provided a substrate (preferably paper, an overhead projector slide or a textile material) printed with an ink comprising a compound of Formula (1) or a salt thereof according to the first aspect of the present invention. Preferably the ink is according to the second aspect of the present invention.

Preferred papers are plain or treated papers which may have an acid, alkaline or neutral character. Examples of commercially available treated papers include: Examples of commercially available plain and treated papers include: Photo Paper Pro (PR101), Photo Paper Plus (PP101), Glossy Photo Paper (GP401), Semi Gloss Paper (SG101), Matte Photo Paper (MP101), (all available from Canon); Premium Glossy Photo Paper, Premium Semi gloss Photo Paper, ColorLife™, Photo Paper, Photo Quality Glossy Paper, Double-sided Matte Paper, Matte Paper Heavyweight, Photo Quality Inkjet Paper, Bright White Inkjet Paper, Premium Plain Paper, (all available from Seiko Epson Corp); HP All-In-One Printing Paper, HP Everyday Inkjet Paper, HP Everyday Photo Paper Semi-glossy, HP Office Paper, HP Photo Paper, HP Premium High-Gloss Film, HP Premium Paper, HP Premium Photo Paper, HP Premium Plus Photo Paper, HP Printing Paper, HP Superior Inkjet Paper, (all available from Hewlett Packard Inc.); Everyday Glossy Photo Paper, Premium Glossy Photo Paper, (both available from Lexmark™ Inc.); Matte Paper, Ultima Picture Paper, Premium Picture Paper, Picture Paper, Everyday Picture Paper (available from Kodak Inc).

Preferred substrates are those having a receptor layer for the ink. The receptor layer may be porous or non-porous,

### Cartridge

According to a fifth aspect of the present invention there is provided an ink jet printer cartridge comprising a chamber and ink, wherein the ink is present in the chamber and the ink comprises a compound of Formula (1) or a salt thereof according to the first aspect of the present invention. Preferably, the ink is according to the second aspect of the present invention.

### Use

According to a sixth aspect of the present invention there is provided the use of a compound of Formula (1) or a salt thereof according to the first aspect of the present invention for preparing an ink (especially an ink jet printing ink) comprising said compound and a liquid medium comprising water, said ink having a conductivity of less than 50 μS/cm.

The invention is further illustrated by the following Examples in which all parts and percentages are by weight unless otherwise stated.

### EXAMPLES

### Example 1

### Preparation of Dye (1)

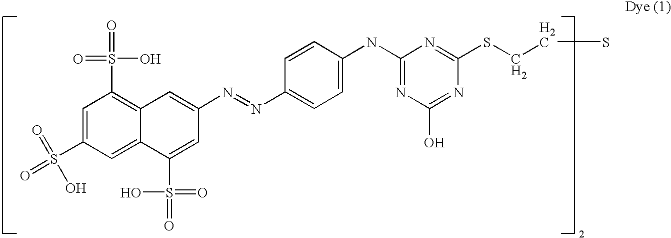

Dye (1) was prepared according to the stages (a) to (c):

### Stage (a): Preparation of Intermediate (1a)

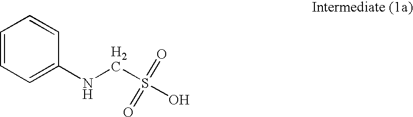

Aniline (511 g, 5.5 mol) was added slowly to a solution of formaldehyde/sodium bisulfite addition compound (740 g, 5.5 mol) in water (1000 ml) at a temperature of 40° C. to form a reaction mixture.

The reaction mixture was stirred for 3 hours at a temperature of 50° C., then sodium chloride (100 g) was added and the reaction mixture was stirred for a further 3 hours whilst allowing the temperature of the reaction mixture to cool to a temperature of 25° C.

The product precipitated. The product was collected by filtration, washed with methylated spirit (3×300 ml) and dried to give 970 g of Intermediate (1a) in the form of a white solid.

### Stage (b): Preparation of Intermediate (1b)

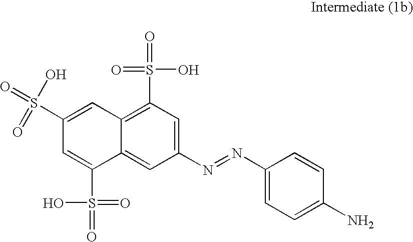

7-aminonaphthalene-1,3,5-trisulfonic acid (76.6 g, 0.2 mol) was dissolved in water (800 ml) and this was adjusted to a pH of 7 by the addition of 2N sodium hydroxide solution, then sodium nitrite (13.8 g, 0.2 mol) was added to form a solution.

The above solution was added dropwise to a mixture of concentrated sulphuric acid (60 g) and water (150 ml) at a temperature of from 0 to 5° C. to form a reaction mixture.

The reaction mixture was stirred for a period of 2 hours at a temperature of from 0 to 5° C. Intermediate (1a) from stage (a) (37.4 g, 0.2 mol) was added in portions over a period of 10 minutes to the reaction mixture at a temperature of from 0 to 5° C., the pH was adjusted to 4-5 by the addition of sodium acetate and the reaction mixture was stirred for a further period of 4 hours still at a temperature of from 0 to 5° C. Sodium hydroxide (100 g) was added to the reaction mixture which was then stirred at a temperature of 80° C. for a further 6 hours.

The reaction mixture was allowed to cool to 25° C. and the product was precipitated by the addition of sodium chloride (200 g). The product was collected by filtration and dried to give 58 g of Intermediate (1b) in the form of an orange solid.

### Stage (c) Preparation of Dye (1):

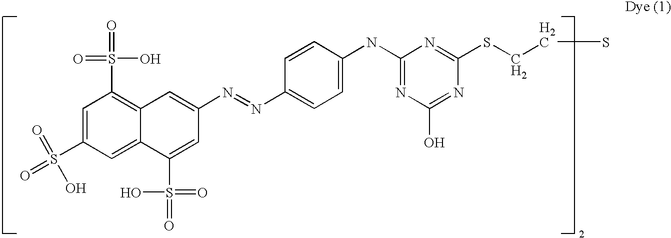

A solution of cyanuric chloride (9.2 g, 0.05 mol) in acetone (10 ml) was added to a mixture of ice/water (300 g) to form a cyanuric chloride suspension.

Intermediate (1b) from stage (b) (24.4 g, 0.05 mol) was dissolved in water (200 ml), adjusted to pH 7 by the addition of 2N lithium hydroxide solution and then added to the above described cyanuric chloride suspension at a temperature of from 0 to 5° C. to form a reaction mixture. The pH of the reaction mixture was maintained at 5-6.5 using 2N lithium hydroxide solution for a period of 1 hour.

2-[(2-mercaptoethyl)thio]ethanethiol (HSCH₂CH₂SCH₂CH₂SH 3.9 g, 0.025 mol) was added to the above reaction mixture. The reaction mixture was stirred at a temperature of 35° C. and a pH of 7-8 (using 2N lithium hydroxide solution) for a period of 18 hours. The reaction mixture was allowed to cool to 25° C. and the resultant precipitate was collected by filtration, washed with acetone (200 ml) and dried to give a solid.

The above solid was dissolved in a solution of LiOH (50 g) in water (500 ml) and the resultant solution was stirred at a temperature of 75° C. for a period of 3 hours.

The product was precipitated by the addition of lithium chloride (100 g) and collected by filtration. The product was dissolved in water (300 ml) and purified by dialysis in membrane tubing to conductivity of less than 50 μS. After evaporating the water at a temperature of 60° C. Dye (1) was obtained (5 g) in the form of an so orange so id and as the lithium salt.

Dye (1) may be used to prepare ink jet printing inks which demonstrate particularly good ozone-fastness, light-fastness, printer operability, ink stability and have a desirable yellow shade.

Further dyes may be prepared in exactly the same way as Example 1 except that 2-[(2-mercaptoethyl)thio]ethanethiol is replaced in the same molar amount with the preferred compounds of Formula HXLXH as hereinbefore described.

### Inks

The inks described in Tables I and II may be prepared wherein the Dye described in the first column is the Dye made in the above Example of the same number. Numbers quoted in the second column onwards refer to the number of parts of the relevant ingredient and all parts are by weight. The inks may be applied to paper by thermal or piezo ink jet printing.

The following abbreviations are used in Table I and II:

PG=propylene glycol

DEG=diethylene glycol

NMP=N-methylpyrrolidone

DMK=dimethylketone

IPA=isopropanol

MeOH=methanol

2P=2-pyrrolidone

MIBK=methylisobutyl ketone

P12=propane-1,2-diol

BDL butane-2,3-diol

CET=cetyl ammonium bromide

PHO Na₂HPO₄ and

TBT=tertiary butanol

TDG=thiodiglycol

TABLE I

| | Dye | | | | | | | Na | | | | |
|---|---|---|---|---|---|---|---|---|---|---|---|---|
| Dye | Content | Water | PG | DEG | NMP | DMK | NaOH | Stearate | IPA | MEOH | 2P | MIBK |
| 1 | 2.0 | 80 | 5 | | 6 | 4 | | | | | 5 | |
| 1 | 3.0 | 90 | | 5 | 5 | | 0.2 | | | | | |
| 1 | 10.0 | 85 | 3 | | 3 | 3 | | | | 5 | 1 | |
| 1 | 2.1 | 91 | | 8 | | | | | | | | 1 |
| 1 | 3.1 | 86 | 5 | | | | | 0.2 | 4 | | | 5 |
| 1 | 1.1 | 81 | | | 9 | | 0.5 | 0.5 | | | 9 | |
| 1 | 2.5 | 60 | 4 | 15 | 3 | 3 | | | 6 | 10 | 5 | 4 |
| 1 | 5 | 65 | | 20 | | | | | 10 | | | |
| 1 | 2.4 | 75 | 5 | 4 | | 5 | | | | 6 | | 5 |
| 1 | 4.1 | 80 | 3 | 5 | 2 | 10 | | 0.3 | | | | |
| 1 | 3.2 | 65 | | 5 | 4 | 6 | | | 5 | 4 | 6 | 5 |
| 1 | 5.1 | 96 | | | | | | | | 4 | | |
| 1 | 10.8 | 90 | 5 | | | | | | 5 | | | |
| 1 | 10.0 | 80 | 2 | 6 | 2 | 5 | | | 1 | | 4 | |
| 1 | 1.8 | 80 | | 5 | | | | | | | 15 | |
| 1 | 2.6 | 84 | | | 11 | | | | | | 5 | |
| 1 | 3.3 | 80 | 2 | | | 10 | | | | 2 | | 6 |
| 1 | 12.0 | 90 | | | | 7 | 0.3 | | 3 | | | |
| 1 | 5.4 | 69 | 2 | 20 | 2 | 1 | | | | | 3 | 3 |
| | 6.0 | 91 | | | 4 | | | | | | 5 | |

TABLE II

| | Dye | | | | | | | | | | | |
|---|---|---|---|---|---|---|---|---|---|---|---|---|
| Dye | Content | Water | PG | DEG | NMP | CET | TBT | TDG | BDL | PHO | 2P | PI2 |
| 1 | 3.0 | 80 | 15 | | | 0.2 | | | | | 5 | |
| 1 | 9.0 | 90 | | 5 | | | | | | 1.2 | | 5 |
| 1 | 1.5 | 85 | 5 | 5 | | 0.15 | 5.0 | 0.2 | | | | |
| 1 | 2.5 | 90 | | 6 | 4 | | | | | 0.12 | | |
| 1 | 3.1 | 82 | 4 | 8 | | 0.3 | | | | | | 6 |
| 1 | 0.9 | 85 | | 10 | | | | | 5 | 0.2 | | |
| 1 | 8.0 | 90 | | 5 | 5 | | | 0.3 | | | | |
| 1 | 4.0 | 70 | | 10 | 4 | | | | 1 | | 4 | 11 |
| 1 | 2.2 | 75 | 4 | 10 | 3 | | | | 2 | | 6 | |
| 1 | 10.0 | 91 | | | 6 | | | | | | 3 | |
| 1 | 9.0 | 76 | | 9 | 7 | | 3.0 | | | 0.95 | 5 | |
| 1 | 5.0 | 78 | 5 | 11 | | | | | | | 6 | |
| 1 | 5.4 | 86 | | | 7 | | | | | | 7 | |
| 1 | 2.1 | 70 | 5 | 5 | 5 | 0.1 | 0.2 | 0.1 | 5 | 0.1 | 5 | |
| 1 | 2.0 | 90 | | 10 | | | | | | | | |
| 1 | 2 | 88 | | | | | | 10 | | | | |
| 1 | 5 | 78 | | | 5 | | | 12 | | | 5 | |
| 1 | 8 | 70 | 2 | | 8 | | | 15 | | | 5 | |
| 1 | 10 | 80 | | | | | | 8 | | | 12 | |
| 1 | 10 | 80 | | 10 | | | | | | | | |

1. A compound of Formula (1) or a salt thereof: 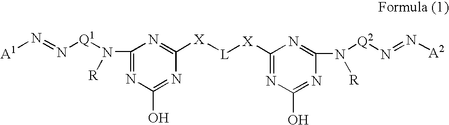
wherein:
A¹ and A² are each independently optionally substituted aryl;
Q¹ and Q² are each independently an optionally substituted arylene or polycyclic heteroarylene group each comprising a phenylene ring which is para connected to the —N═N— and the —NR— groups shown in Formula (1);
each R is independently H or a substituent;
each X is independently selected from O, S or NR^{a} wherein R^{a} is H or a substituent, provided that at least one of the groups represent by X is O or S;
L is a linking group; and
provided that the groups represented by the formula XLX do not contain any group selected from sulfonic acid, phosphonic acid, carboxylic acid and sulfonamide groups.

2. A compound or a salt thereof according to claim 1 wherein each group represented by X is independently selected from O and S.

3. A compound or a salt thereof according to claim 2 wherein both of the groups represented by X are either O or S.

4. A compound or a salt thereof according to claim 1 wherein the residue represented by the groups -XLX- is of the formula —O(CH₂)₁₆O—, —O(CH₂)₂N(CH₃)(CH₂)₂O—, —OCH₂CH₂OCH₂CH₂OCH₂CH₂O—, —OCH₂CH₂OCH₂CH₂O—, —OCH₂CH₂SCH₂CH₂O—, —O(CH₂)₃S(CH₂)₃O—, —O(CH₂)₄—, —OCH₂CH₂C(CH₃)CH₂CH₂O—, —O(CH₂)₃—O—(CH₂)₃O—, —S(CH₂)₈S—, —SCH₂CH₂OCH₂CH₂S—, —S(CH₂)₄S—, —S(CH₂)₆S—, —SCH₂CH₂OCH₂CH₂OCH₂CH₂S—, —S(CH₂)₁₀S—, —SCH(CH₃)CH₂CH₂S—, —SCH₂CH₂SCH₂CH₂S— or —SCH₂CH₂SCH₂CH₂CH₂SCH₂CH₂S—.

5. A compound or a salt thereof according to claim 1 wherein both Q¹ and Q² are optionally substituted phenylene.

6. A compound or a salt thereof according to claim 1 wherein each of the groups represented by Q¹ and Q² are independently unsubstituted or are substituted with only one C₁₋₄ alkyl or C₁₋₄ alkoxy group.

7. (canceled)

8. A compound or a salt thereof according to claim 1 wherein A¹ and A² are each independently of Formula (2) or a salt thereof or Formula (3) or a salt thereof, 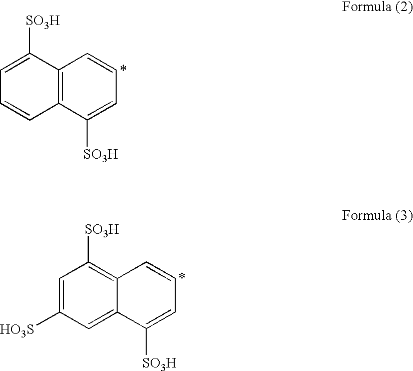
wherein the asterisk represents the point of attachment to the —N═N— group.

9. A compound or a salt thereof according to claim 1 of Formula (4), (5) or (6) or salts thereof:

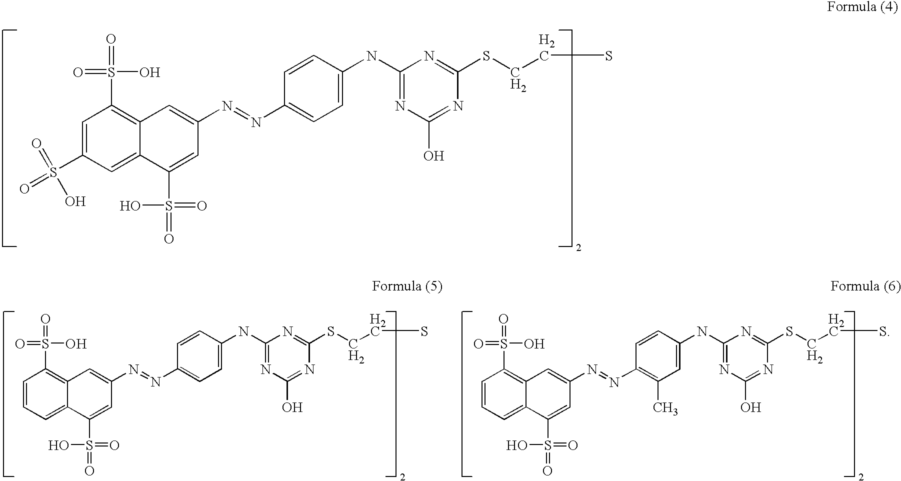

10. A compound or a salt thereof according to claim 1 which is a water-soluble dye.

11. A compound or a salt thereof according to claim 1 having from 1 to 10 groups selected from sulfonic acid, phosphonic acid and carboxylic acid groups.

12. (canceled)

13. An ink comprising:
(a) at least one compound of Formula (1) or a salt thereof according to claim 1; and
(b) a medium.

14. (canceled)

15. A process for printing an image on a substrate comprising applying an ink containing a compound or a salt thereof according to claim 1 to the substrate wherein the ink is applied by means of an ink jet printer.

16. (canceled)

17. A substrate printed with an ink comprising a compound of Formula (1) or a salt thereof according to claim 1.

18. An ink jet printer cartridge comprising a chamber and ink, wherein the ink is present in the chamber and the ink comprises a compound of Formula (1) or a salt thereof according to claim 1.

19. An ink comprising a compound according to claim 1 and a liquid medium comprising water, said ink having a conductivity of less than 50 μS/cm.
